(19) United States
(12) Patent Application Publication
(10) Pub. No.: US 2015/0135998 A1
(43) Pub. Date: May 21, 2015

(54) Shelf attachment for flat panel displays

(71) Applicant: GARY BARSCH, GREENFIELD, WI (US)

(72) Inventor: GARY BARSCH, GREENFIELD, WI (US)

(21) Appl. No.: 14/538,017

(22) Filed: Nov. 11, 2014

Related U.S. Application Data
(60) Provisional application No. 61/907,129, filed on Nov. 21, 2013.

(51) Int. Cl. A47B 96/02; A47B 97/00; G06F 1/16; A47B 57/04

(52) U.S. Cl. CPC A47B 96/02; A47B 57/04; A47B 97/00; G06F 1/1607; A47B 2097/005
USPC 108/42

(57) ABSTRACT

A shelf attachment for a flat panel display having a flat plate that can be positioned horizontally on the top edge of a flat panel display. The shelf attachment includes a flange on a first end thereof that extends downward therefrom onto the front of the flat panel display in order to maintain the flat plate in position. The bottom surface of the flat plate may further include hook and loop fastening material that engages with a strip of hook and loop fastening material positioned on the top edge of the flat panel display. An adjustable support arm is pivotally secured to the bottom surface of the flat plate at a second end thereof. The adjustable support arm rests against the back of the flat panel display in order to provide the flat plate with stability so that it can be maintained in position on the flat panel display.

### CROSS REFERENCE TO RELATED APPLICATION

This application claims the benefit of U.S. Provisional Application No. 61/907,129 filed on Nov. 21, 2013. The above identified patent application is herein incorporated by reference in its entirety to provide continuity of disclosure.

### BACKGROUND OF THE INVENTION

1. Field of the Invention

The present invention relates to shelf attachments for display monitors or screens. More specifically, the present invention provides a shelf attachment adapted to be positioned on the top edge of a flat panel display. The front of the shelf is positioned on the front edge of the flat panel display, and the shelf extends behind the flat panel display. An adjustable support arm is pivotally secured to the bottom surface of the shelf and can be positioned against the back of the flat panel display so as to provide support and stability to the shelf attachment.

Flat panel displays are commonly used as monitors for televisions and for computers. Flat panel displays include liquid crystal displays (LCD), plasma display panels (PDP), and light emitted diode (LED) displays. Such displays can be produced in a variety of sizes, and often consume a considerable amount of space on a desk or television stand. As such, these displays provide little room for the placement of peripheral devices and do not provide areas for storage of other items.

The thin profile of flat panel displays eliminates the ability for objects or items to be positioned on the top edge thereof. People may desire to place items adjacent to their flat panel display, particularly where the display is used as a television. People may have one or more remote controls, DVDs, TV guides, and various other items that they wish to store nearby their television. Thus, the lack of storage space in the area around the flat panel display is inconvenient for users, and requires the users to place such items in other areas.

The present invention provides a shelf attachment for a flat panel display comprising a flat plate that can be positioned on the top edge of a flat panel display. The flat plate comprises a flange on a first end thereof that extends onto the front of the flat panel display and helps to maintain the flat plate in position on the top edge of the flat panel display. The flat plate is positioned so that it extends behind the flat panel display. The flat panel also includes a second end having an adjustable support arm pivotally secured to a bottom surface thereof. The adjustable support arm is attached to the second end of the flat plate via a hinge that allows the adjustable support arm to pivot. The adjustable support arm is adapted to rest against the back of the flat panel display in order to provide support to the flat plate and to help maintain the flat plate in a particular position.

2. Description of the Prior Art

Devices have been disclosed in the prior art that relate to shelves for use in work spaces and entertainment centers. These include devices that have been patented and published in patent application publications. These devices generally relate to shelves for televisions and computer display monitors. The following is a list of devices deemed most relevant to the present disclosure, which are herein described for the purposes of highlighting and differentiating the unique aspects of the present invention, and further highlighting the drawbacks existing in the prior art.

One such device, U.S. Patent Application Publication Number 2009/0008349 to Kim, discloses a shelf to be disposed on top of a display device, such as an LCD display. The shelf comprises a flat plate having a coupling panel that attaches to the front of the display and a rear support that secures the plate to the rear of the display. The rear support includes at least one fixing member that passes therethrough to secure the plate on the display. The shelf includes a support panel secured to the plate by a connecting panel and secured to the display by a rear connecting panel, wherein the rear connecting panel is screwed to the rear of the display. Thus, while Kim discloses a shelf to be disposed on a display, Kim does not disclose a shelf with an adjustable support arm. Rather, Kim discloses securing a plate to the display using a coupling panel and a rear support having one or more fixing members. Further, the support panel or arm of Kim is permanently secured to the display by means of a screw.

U.S. Pat. No. 8,009,414 to Ishida et al. discloses an electronic equipment and shelf member comprising a main body that supports a flat panel display and a shelf member on which articles can be positioned. The flat panel display is adapted to be pivoted into a desired viewing position independently of the position of the shelf. In this way, the flat panel display can be adjusted without also moving the shelf and articles thereon. Thus, Ishida et al. fails to disclose a shelf attachment for a flat panel display comprising a flat plate having a support arm adjustably positioned against the flat panel display. Instead, Ishida et al. discloses a device having a main body to which a display and a shelf member are secured.

U.S. Pat. No. 7,341,235 to Okamoto discloses a fixture for a display unit having a rack with a first shelf on which a display is positioned, and a second shelf disposed above the display unit. The second shelf is fixed to the display unit by a fixture that allows for rotation of the display. In this way, when vibrations from a printer or similar device positioned on the second shelf occur, the display is prevented from being resonated by the fixture. Thus, Okamoto does not disclose a shelf attachment including a flat plate with a support arm extending from a bottom surface thereof, and that is adapted to be positioned against the back of a flat panel display.

U.S. Pat. No. 3,485,382 to Larson discloses a shelf support for use with pegboard displays. The shelf support is adapted to support a planar shelf on an upstanding pegboard in a variety of angular positions relative to the position of the pegboard. The shelf support comprises an elongated support arm extending from the pegboard to the planar shelf. The support arm includes a stop means that prevents a shelf from sliding outwardly and off of the shelf support when disposed in an angular position less than ninety degrees relative to the pegboard. Thus, Larson discloses a shelf support for use with a pegboard, and does not disclose a shelf attachment that can be removably positioned on the top edge of a flat panel display.

U.S. Pat. No. 6,527,247 to Jacob discloses an article support stand for use with a computer monitor. The article support stand includes an article holder for a book or similar item that is disposed at an angle suitable for reading. The article holder is slidably attached to a horizontal beam, which is attached to an upright post. The upright post is disposed on two adjustable feet that are positioned adjacent to the monitor's base and having a tongue portion that is placed underneath the monitor base. Thus, Jacob discloses an article support stand, but does not disclose a shelf disposed horizontally on the top edge of a flat panel display.

U.S. Pat. No. 4,730,738 to Bartus et al. discloses a shelf system having a hingedly mounted shelf. The shelf includes a brace piece with a contoured back portion that provides elements disposed progressively inwardly with respect to a vertical axis. Thus, Bartus et al. fails to disclose a shelf attachment that can be removably positioned on the top edge of a flat panel display, and that includes an adjustable support arm to provide stability to the shelf.

These prior art devices have several known drawbacks. While devices in the prior art disclose shelves for use with computers or displays, these devices are not adjustable and are inconvenient to install and uninstall. Some of such devices are permanently affixed to the computer or display using fasteners such as screws or bolts. Thus, in order to install such shelves, users must use tools to affix the shelf to the display. Further, shelves that are not directly attached to a flat panel display require a user to affix a shelf to a mounting surface, such as a wall. Affixing a shelf to a wall or other surface may be undesirable in that a user must create holes in the wall in which fasteners can be inserted. Other devices disclose adjustable shelves, but such devices are not adapted to be positioned on the top edge of a flat panel display. This is disadvantageous because flat panel displays consume considerable space and do not provide a means for storing objects thereon. The present invention overcomes these drawbacks by providing a shelf that may be removably attached to a flat screen panel display. Therefore, the present invention provides means for storing objects above flat panel displays while eliminating the need for the user to permanently mount the device onto a supporting structure.

In light of the devices disclosed in the prior art, it is submitted that the present invention substantially diverges in design elements from the prior art and consequently it is clear that there is a need in the art for an improvement to existing shelf attachment devices for use with flat panel displays. In this regard the instant invention substantially fulfills these needs.

### SUMMARY OF THE INVENTION

In view of the foregoing disadvantages inherent in the known types of shelves now present in the prior art, the present invention provides a new shelf attachment for use with a flat panel display wherein the same can be utilized for providing convenience for the user when storing articles on a flat panel display.

It is therefore an object of the present invention to provide a new and improved shelf attachment device that has all of the advantages of the prior art and none of the disadvantages.

It is another object of the present invention to provide a shelf attachment for use with a flat panel display that provides storage space on the top edge of a flat panel display.

Another object of the present invention is to provide a shelf attachment for use with a flat panel display that can be removably positioned on a flat panel display without the use of permanent fasteners.

A further object of the present invention is to provide a shelf attachment for use with a flat panel display comprising a flange thereon that helps to maintain the position of the shelf on the flat panel display.

Yet another object of the present invention is to provide a shelf attachment for use with a flat panel display comprising an adjustable support arm that helps to maintain the position of the shelf on the top edge of the flat panel display.

Another object of the present invention is to provide a shelf attachment for use with a flat panel display that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the shelf attachment of the present invention as secured to a flat panel display.

FIG. 2A shows a side view of the shelf attachment of the present invention as positioned for installation on a flat panel display.

FIG. 2B shows a side view of the shelf attachment of the present invention as mounted on a flat panel display.

FIG. 3 shows a side view of an alternate embodiment of the shelf attachment of the present invention as positioned for installation on a flat panel display.

FIG. 4 shows a perspective view of the shelf attachment of the present invention and the adjustable support arm thereon.

### DETAILED DESCRIPTION OF THE INVENTION

Reference is made herein to the attached drawings. Like reference numerals are used throughout the drawings to depict like or similar elements of the shelf attachment of the present invention. For the purposes of presenting a brief and clear description of the present invention, the preferred embodiment will be discussed as used for providing storage space on the top of a flat panel display. The figures are intended for representative purposes only and should not be considered to be limiting in any respect.

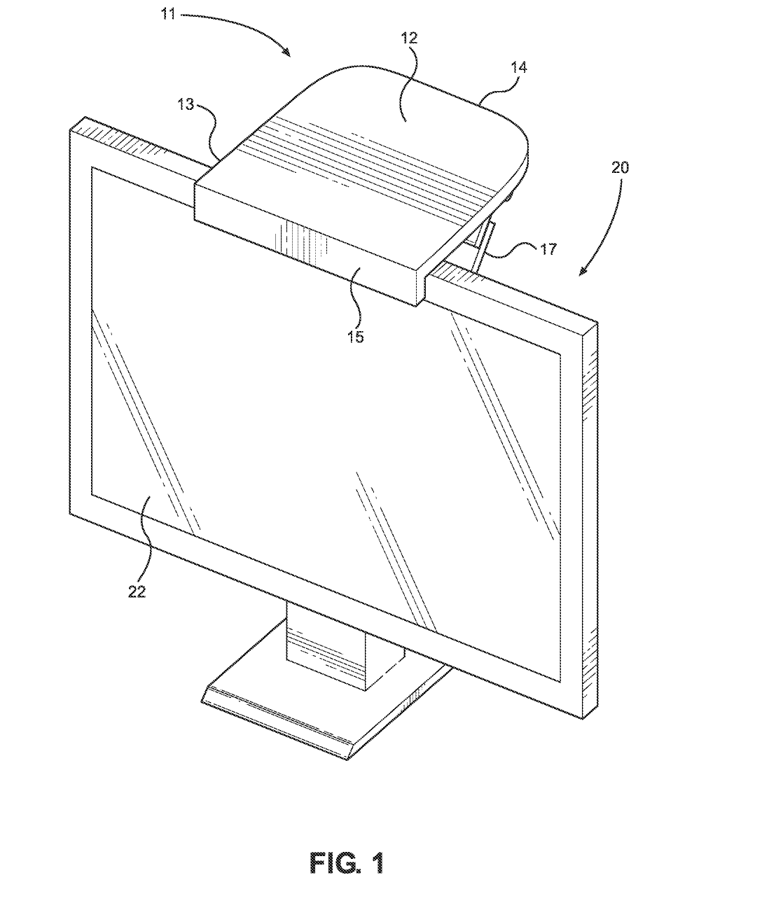

Referring now to FIG. 1, there is shown a perspective view of the shelf attachment of the present invention as secured to a flat panel display. The present invention provides a shelf attachment 11 comprising a flat plate 12 adapted to be disposed horizontally on the top of a flat panel display 20, such as an LCD or LED television or monitor, and a support arm 17 that is used to stabilize and support the flat plate 12. In this way, the flat plate 12 serves as a shelf on which various objects and articles can be positioned. Devices such as remote controls and cable boxes may be positioned on the shelf so as to provide a convenient storage space for various small items and objects. Alternatively, the shelf attachment 11 may be used to hold decorative items in order to enhance the aesthetic appeal of the flat panel display 20.

The flat plate 12 has a first end 13 adapted to be positioned on top of a flat panel display 20, and a second end 14 that extends behind the flat panel display 20. The first end 13 is positioned adjacent to the front of the flat panel display 20 and is substantially parallel thereto. In the illustrated embodiment, the flat plate 12 comprises a rectangular shape wherein the first end 13 is substantially linear, and the second end 14 comprises rounded corners. In alternate embodiments, the flat plate 12 comprises any of a variety of shapes, such as a semi-circular shape.

The first end 13 comprises a flange 15 thereon that extends downwardly from a bottom surface of the flat plate 12. The flange 15 is substantially perpendicular to the flat plate 12 and is preferably linear so that it follows the contours of the periphery of the flat panel display 20 and does not interfere with the screen portion of the flat panel display 20. The flange 15 is adapted to be positioned flush against the front surface 22 of the flat panel display 20. In this way, the flange 15 helps to secure the shelf attachment 11 in a particular position on top of the flat panel display 20. The flange 15 also prevents the shelf attachment 11 from sliding backwards and off of the flat panel display 20.

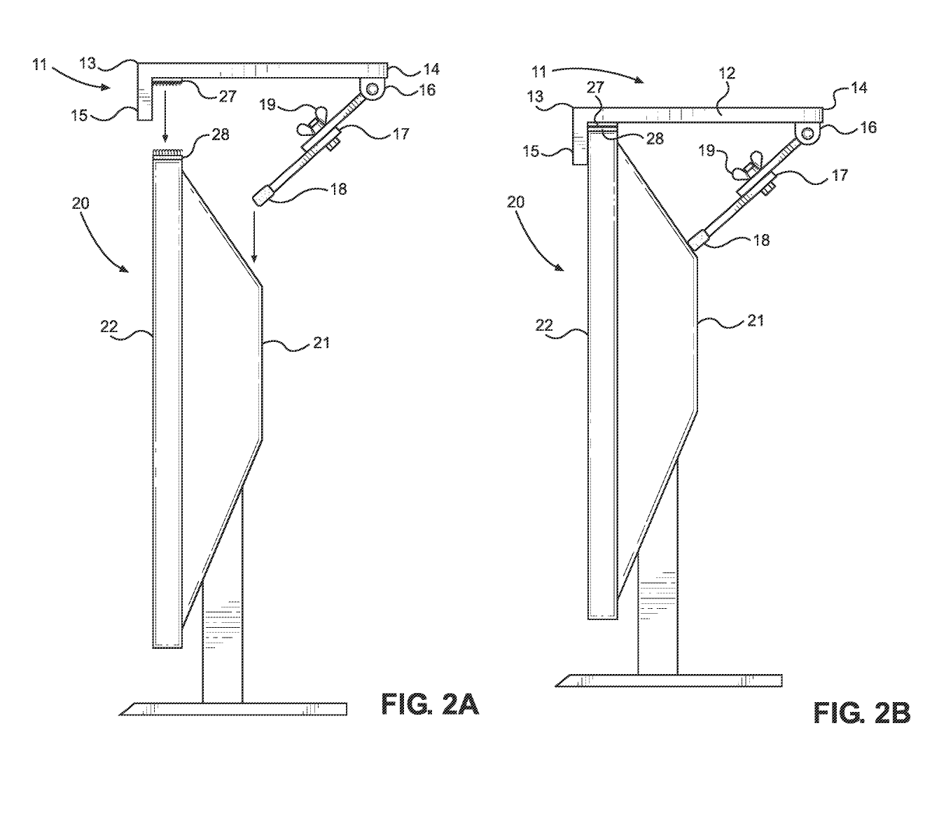

Referring now to FIGS. 2A and 2B, there are shown side views of the shelf attachment of the present invention as positioned for installation on a flat panel display, and as mounted thereto. In some embodiments of the present invention, the flat plate 12 comprises a first strip of hook and loop fastening material 27 on a bottom surface thereof that helps to secure the flat plate 12 in a particular position on the flat panel display 20. The first strip of hook and loop fastening material 27 may have an adhesive backing to secure the strip to the bottom surface of the flat plate 12. The first strip of hook and loop fastening material 27 is positioned near the first end 13 of the flat plate 12, and adjacent to the flange 15 thereon. The first strip 27 extends laterally on the flat plate 12 such that it is parallel to the flange 15, and extends between opposing sides of the flat plate 12.

A second strip of hook and loop fastening material 28 can be positioned along the top edge of a flat panel display 20. The second strip 28 comprises an adhesive backing such that the second strip 28 can be adhesively secured to the top edge of the flat panel display 20 with the hook and loop fastening material facing upward. The first strip of hook and loop fastening material 27 disposed on the flat plate 12 can be engaged with the second strip 28 so that the flat plate 12 is held in position on the top edge of the flat panel display 20.

The second end 14 of the flat plate 12 comprises a hinge 16 on the bottom surface thereof. Preferably the hinge 16 is located centrally on the second end 14 of the flat plate 12. An adjustable support arm 17 is secured at a first end to the hinge 16 and comprises a foot 18 on a second end thereof. The foot 18 is preferably composed of a high-friction material such as rubber so that the foot 18 will remain in a particular position on the rear 21 of the flat panel display 20. Additionally, the foot 18 helps to prevent the adjustable support arm 17 from scratching or damaging the back of the flat panel display 20. The adjustable support arm 17 helps to stabilize the flat plate 12 and supports the weight of objects placed thereon.

The adjustable support arm 17 is adapted to pivot about the hinge 16 so that the support arm 17 can be positioned at a desired angle with respect to the flat plate 12. The angle selected will depend upon the particular flat panel display on which the shelf attachment 11 is installed. The adjustable arm 17 can be extended or retracted so that the foot 18 of the adjustable support arm 17 contacts the rear 21 of the flat panel display 20. Once extended to the desired length, a fastener 19 is used to secure the adjustable support arm 17 at the desired length. Thus, the hinge 16 and adjustable support arm 17 provide the user with flexibility in installing the shelf attachment 11, and allows the shelf attachment 11 to be used with any of a variety of flat panel displays.

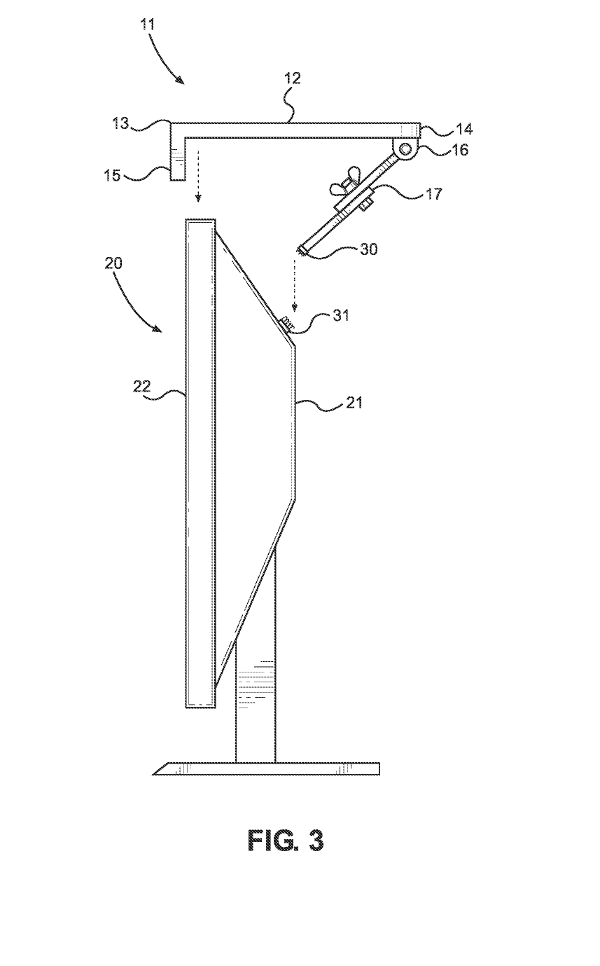

Referring now to FIG. 3, there is shown a side view of an alternate embodiment of the shelf attachment of the present invention as positioned for installation on a flat panel display. The illustrated embodiment includes a first strip of hook and loop fastening material 30 on an end of the support arm 17 in the place of the rubber foot. A second strip of hook and loop fastening material 31 can be positioned on the rear 21 of the flat panel display 20 in the place where the support arm 17 will engage the flat panel display 20. The second strip of hook and loop fastening material 31 can be secured to the rear 21 of the flat panel display 20 by means of an adhesive on the rear surface of the second strip of hook and loop fastening material 31. In this way, the first strip of hook and loop fastening material 30 on the support arm 17 can be engaged with the second strip of hook and loop fastening material 31 on the rear 21 of the flat panel display 20 in order to secure the support arm 17 in a desired position. This helps to prevent the support arm 17 from slipping or moving on the rear 21 of the flat panel display 20, ensuring that the support arm 17 will support and stabilize the flat plate 12.

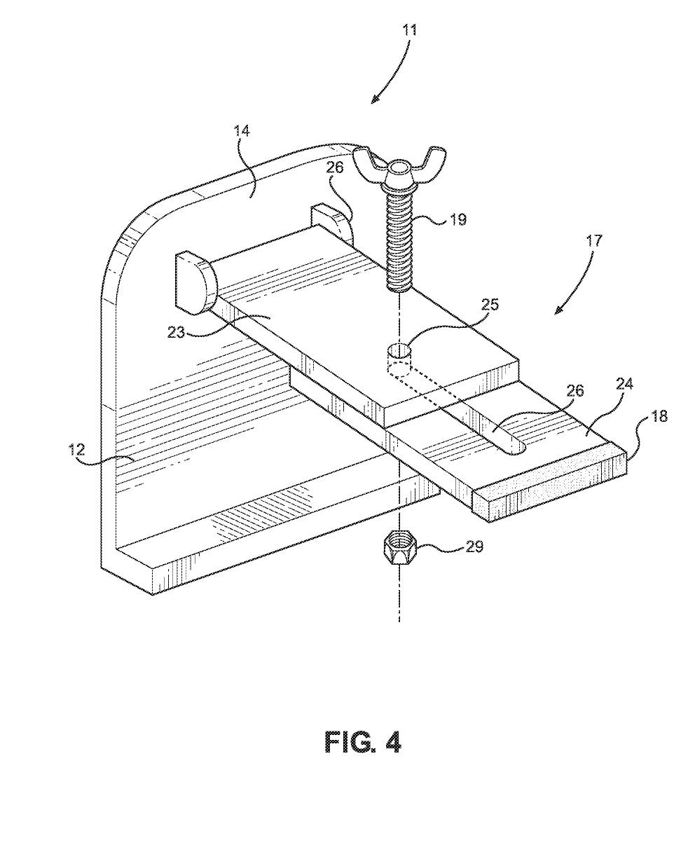

Referring now to FIG. 4, there is shown a perspective view of the shelf attachment of the present invention and the adjustable support arm thereon. The adjustable support arm 17 comprises a first section 23 that is attached to the hinge 16 at a first end and that comprises an aperture 25 near a second end thereof. The adjustable support arm 17 further comprises a second section 24 that includes an elongated slot 26 along the length thereof and a foot 18 on an end thereof. The second section 24 is independent from the first section 23. The second section 24 partially overlaps the first section 23 such that the aperture 25 and a portion of the elongated slot 26 are aligned. In the illustrated embodiment, the first section 23 is disposed on top of the second section 24. The user can extend the second section 24 to the extent required for the foot 18 of the second section 24 to contact the back of a flat panel display. The second section 24 can then be secured in place with respect to the first section 23 by inserting a fastener 19, such as a bolt or other similar fastener, through both the elongated slot 26 and aperture 25. A nut 29 or wing nut can be threaded onto the bolt 19 in order to secure the first section 23 and second section 24 in a particular position with respect to one another.

Thus, the present invention provides a shelf attachment for flat panel displays comprising a flat plate having a first end and a second end. The flat plate is adapted to be positioned on the top edge of a flat panel display such that the first end thereof is adjacent to the front of the flat panel display. The first end further includes a flange thereon that helps to maintain the position of the flat plate on the flat panel display. The bottom surface of the flat plate may include hook and loop fastening material thereon that engages with a strip of hook and loop fastening material disposed on the top edge of the flat panel display. The second end of the flat plate comprises a hinge on the bottom surface thereof to which an adjustable support arm is pivotally attached. The adjustable support arm can be positioned at a desired angle, and can be extended to the length required for the adjustable arm to contact the back of the flat panel display. A rubber foot is positioned at the end of the adjustable support arm and is adapted to contact the back of the flat panel display. The adjustable support arm provides support and stability to the flat plate so that it remains securely in position on the flat panel display and so that the flat plate can support the weight of objects placed thereon. In this way, the present invention provides an easily installed and removed shelf for flat panel displays that provides storage space thereon, and that does not require the user to use any tools or perform any assembly.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A shelf attachment for a flat panel display, comprising
a flat plate having a first end and a second end, wherein said flat plate is adapted to be positioned on a top edge of a flat panel display;
wherein said first end of said flat plate comprises a flange that extends downward therefrom and that is perpendicular to said flat plate;
an adjustable support arm having a first end and a second end;
wherein a first end of said adjustable support arm is pivotally secured to a hinge disposed on a bottom surface of said flat plate at said second end thereof;
wherein said second end of said adjustable support arm is adapted to contact a rear surface of said flat panel display.

2. The shelf attachment of claim 1, wherein
said flat plate comprises a substantially rectangular shape.

3. The shelf attachment of claim 1, wherein
said flat plate comprises a semi-circular shape.

4. The shelf attachment of claim 1, wherein
said flange extends along said first end of said flat plate.

5. The shelf attachment of claim 1, wherein
said bottom surface of said flat plate at said first end comprises a first strip of hook and loop fastening material thereon;
wherein said first strip is adapted to be secured to a second strip of hook and loop fastening material positioned on said top edge of said flat panel display.

6. The shelf attachment of claim 5, wherein
said first strip of hook and loop fastening material spans a length of said first end of said flat plate;
a length of said second strip of hook and loop is substantially equal to said length of said first strip on said first end of said flat plate.

7. The shelf attachment of claim 1, wherein
said adjustable support arm comprises a first section adjustably secured to a second section;
wherein said first section comprises an aperture thereon;
wherein said second section comprises an elongated slot; and
wherein said first section partially overlaps said second section such that a portion of said elongated slot is aligned with said aperture;
wherein a fastener is inserted through said aperture and said elongated slot so as to hold said second section in a desired position with respect to said first section.

8. The shelf attachment of claim 7, wherein
said fastener comprises a bolt and a nut.

9. The shelf attachment of claim 1, wherein
said second end of said adjustable support arm comprises a foot that is composed of rubber.

10. The shelf attachment of claim 1, wherein
said second end of said adjustable support arm includes a first strip of hook and loop fastening material thereon;
wherein said first strip of hook and loop fastening material is adapted to be engaged with a second strip of hook and loop fastening material secured to said rear surface of said flat panel display.
